(19) United States
(12) Patent Application Publication
(10) Pub. No.: US 2025/0055083 A1
(43) Pub. Date: Feb. 13, 2025

(54) Energy Storage Cell, and Method for Producing an Energy Storage Cell

(71) Applicant: Bayerische Motoren Werke Aktiengesellschaft, Muechen (DE)

(72) Inventors: Christoph BORN, Muenchen (DE); Niclas EMRICH, Muenchen (DE); Simon HAERLE, Muenchen (DE); Martin HILLER, Karlsfeld (DE); Matthias SCHERER, Muenchen (DE); Seokyoon YOO, Muenchen (DE)

(21) Appl. No.: 18/720,065

(22) PCT Filed: Feb. 9, 2023
(86) PCT No.: PCT/EP2023/053194

§ 371 Date: Jun. 14, 2024

(30) Foreign Application Priority Data
Mar. 14, 2022 (DE) 10 2022 105 884.0

(51) Int. Cl. H01M 50/107; B23K 20/06; B23K 101/36; H01G 11/80; H01G 11/84; H01M 10/0525; H01M 50/531; H01M 50/545; H01M 50/547

(52) U.S. Cl. CPC H01M 50/107; H01G 11/80; H01G 11/84; H01M 10/0525; H01M 50/531; H01M 50/545; H01M 50/547; B23K 20/06; B23K 2101/36

(57) ABSTRACT

An energy storage cell, in particular a lithium-ion cell, comprising an in particular cylindrical housing main body which extends along a longitudinal axis and forms an arrangement space in which electrode material that is electrically conductively connected to the housing main body is arranged. The arrangement space is delimited at a second end by a cover element and at a first end by a base element. The base element is fastened electrically conductively and gas-tightly to the housing main body by electromagnetic pulse welding.

### BACKGROUND AND SUMMARY

This disclosure relates to an energy storage cell and to a method for producing an energy storage cell.

Electrical energy storage cells, such as round cells, are used in all types of electrical appliances and increasingly also for traction batteries of partially or fully electrically powered motor vehicles. EP 3 696 874 A1 and EP 3 726 617 A1 disclose two typical structural designs of this type of cell. A cell wrap is located inside a cylindrical housing body. For the purpose of forming two poles, this cell wrap has been routed outward, at an end face in each instance, via corresponding conductor elements. One challenge that arises in the course of the production of such cells consists in the fact that the cells have to be reliably gastight. Weld seams can be problematic in this context. The thermal input arising in the course of welding can also result in components or structural members being exposed to an impermissibly high loading. For the purpose of protection against corrosion, for example, the housing bodies often exhibit a coating that may possibly be destroyed in the course of welding.

It is therefore an object of the present disclosure to specify an energy storage cell and also a method for producing an energy storage cell, wherein the aforementioned disadvantages are to be avoided, and wherein an energy storage cell is made available that satisfies the most stringent quality requirements.

In accordance with the disclosure, an energy storage cell, in particular a lithium-ion cell, includes a housing body, in particular a cylindrical housing body, which extends along a longitudinal axis and forms an arrangement space in which electrode material is arranged which has been connected to the housing body in electrically conducting manner, wherein the arrangement space is delimited at a second end by a cover element, and at a first end by a base element, and wherein the base element has been fastened to the housing body in electrically conducting and gastight manner by electromagnetic pulse welding. According to a preferred embodiment, the energy storage cell is a round cell. Correspondingly, the housing body preferably has a (hollow) cylindrical shape. Preferred materials for the housing body are nickel, steel, stainless steel or nickel-plated steel or a mixture of the aforementioned materials. According to a preferred embodiment, the housing body has been produced from a steel material including a layer for protection against corrosion. According to a preferred embodiment, the layer for protection against corrosion is constituted by a layer of nickel. According to a preferred embodiment, the material known as Hilumin is used for the housing body. This material is a diffusion-cooled strip steel with an electrolytic nickel coating. This strip steel is distinguished by a low contact resistance and a high corrosion resistance. The aforementioned materials, or structural members, are expediently joined very sparingly by the electromagnetic pulse welding. The aforementioned welding method expediently introduces hardly any heat into the partners to be joined. It is therefore possible to weld together metallic materials having greatly differing melting-points. In addition, no influencing of the structure arises by virtue of heat. Consequently it is possible, for instance, to establish connections of materials without changing the strength-determining structure thereof. By virtue of the electromagnetic pulse welding, mixed connections of materials, but also materials of the same type, can be connected without heat within an extremely short time with the aid of the method of magnetic forming, by one of the partners to be joined experiencing an impulse in non-contacting manner by way of a magnetic field, and colliding with the other partner. By virtue of the high speed of the collision of the partners to be joined, a connection by material closure occurs in a solid phase.

According to one embodiment, the electrode material is an electrode wrap. The latter is also designated as a “jelly roll”. According to a preferred embodiment, the energy storage cell is a lithium-ion cell. However, the disclosure is not restricted to this type of cell or to this cell chemistry. According to one embodiment, the energy storage cell may also be, for instance, a supercap.

According to one embodiment, the base element exhibits a contact surface peripherally for the purpose of fastening to the housing body. The base element expediently includes a central portion. According to one embodiment, the central portion takes the form of a (circular) disk or plate. According to one embodiment, the contact surface has been formed peripherally on the central portion in the form of a line. According to one embodiment, the contact surface bears against the housing body on the inside.

As mentioned previously, in the case of electromagnetic pulse welding there is a structural member that experiences an impulse and accordingly is subsequently moved. In the aforementioned embodiment, the housing body is expediently moved toward the base element, or toward the contact surface thereof. Accordingly, in such an embodiment use is made, for instance, of a round magnetic coil which is arranged in such a manner that the housing body is accelerated radially in the direction of the prepositioned base element. In the present case, the region of the housing body that is accelerated is also called the fastening portion. According to one embodiment, this fastening portion may have been generated, for instance, by reshaping. In principle, this portion should expediently be designed in such a way that a joining gap toward the base element is present which is closed in the course of the electromagnetic pulse welding.

According to one embodiment, a contact link extends from the central portion in the direction of the arrangement space or away therefrom. The aforementioned contact surface has been formed on the contact link on the inside or on the outside. In this embodiment, the contact surface has been designed to be “planar”. Depending upon the configuration or embodiment, the contact link may bear against the housing body on the inside or on the outside. The contact link may also be designated as a type of “flange” which extends away from the central portion in substantially perpendicular manner. Depending on whether the flange, or contact link, bears against the housing body on the inside or on the outside, either the housing body, or the fastening portion thereof, or the contact link, or flange, has been designed as the partner to be joined that in the course of the electric pulse welding is relocated toward the respective other partner to be joined. Also in the aforementioned embodiments, the fastening of the base element to the housing body is expediently effected peripherally. The impulse that is generated in the course of the electromagnetic pulse welding is accordingly directed radially in the direction of a central axis of the housing body.

According to an alternative embodiment, the impulse may also have been directed along the longitudinal axis. For this purpose, the housing body exhibits, for instance in the region of the second end, a frontal link or flange. The latter can serve as partner to be joined for a base element arranged thereon. In this embodiment, the base element exhibits a plate-shaped or disk-shaped central portion which on its outer periphery exhibits a corresponding contact surface for abutment against the frontal end of the housing body. The region of the base element that forms the contact surface may, in a first step, have been angled or inclined toward the rest of the base element, or toward the central portion, in order then to be able to be accelerated toward the frontal end of the housing body with the aid of the electromagnetic pulse welding, as a result of which the gastight fastening is brought about. Alternatively, the base element as such can be accelerated toward the housing body for the purpose of fastening.

Expediently in the present case, no further precautions have to be taken for the purpose of establishing the impermeability to gas. In particular, no separate sealing or such like is necessary, since the electromagnetic pulse welding alone advantageously makes the gastight connection, or fastening, possible. The structural members, or partners to be joined, have been designed and positioned in such a manner that a peripherally closed welded connection is capable of being generated which seals the housing body in gastight manner at the first end.

According to one embodiment, the housing body has been connected to the electrode material in electrically conducting manner via a contact element. The contact element expediently exhibits a contact surface peripherally. According to one embodiment, the contact element has been fastened to the housing body by electromagnetic pulse welding, in particular indirectly via the aforementioned contact surface. According to one embodiment, the contact element exhibits a (circular-) disk-shaped or plate-shaped central portion on which the contact surface has been formed peripherally.

According to one embodiment, the contact element exhibits a central portion and also a peripherally arranged contact link which extends away from or is oriented away from the arrangement space.

A resistance-welding method—such as, for instance, cold pressure welding, friction welding or ultrasonic welding—can be used for the purpose of fastening the contact element to the housing body. Particularly preferred welding methods are: resistance welding, projection welding or gap welding. The contact element has expediently been connected to the electrode material by material closure. Laser welding preferably comes into operation by way of joining technique for this purpose.

According to one embodiment, the contact element has likewise been fastened to the housing body by electromagnetic pulse welding, in particular on the inside.

According to one embodiment, the contact surfaces—that is to say, the contact surfaces both of the contact element and of the base element—have been designed and positioned to be fastened simultaneously by the electromagnetic pulse welding.

According to one embodiment, the contact surfaces each contact the housing body directly. In this embodiment, both the base element and the contact element exhibit, for instance, contact links which are oriented away from the arrangement space. The contact surfaces formed on the contact links bear against the housing body internally. The contact element and the base element are arranged in succession along the longitudinal axis. The base element closes off the arrangement space. Toward the first end, the housing body has been formed in such a manner that it can be accelerated toward the contact links in the course of the electromagnetic pulse welding. According to one embodiment, the housing body has, for instance, been appropriately widened peripherally. According to one embodiment, the contact element has already been fastened in some other way, in particular by material closure. Only the base element is fastened to the housing body from the inside by electromagnetic pulse welding. The configuration of the base element, including the contact link oriented away from the arrangement space, advantageously makes the arrangement of a supporting element possible, so that the housing body is accelerated in the radial direction from the outside in the direction of the contact link which is expediently supported radially from the inside.

According to one embodiment, the base element exhibits a contact link oriented toward the arrangement space, which bears against the housing body on the outside. In combination with an appropriately inversely formed contact element which exhibits a contact link that is oriented away from the arrangement space, an embodiment can be realized in which the contact element itself is able to act as supporting element. Viewed in the radial direction from the inside to the outside, the contact link of the contact element is arranged first of all, followed by the housing body, and followed in turn by the contact link of the base element, bearing against the housing body peripherally. This contact link of the base element is the structural member that is accelerated toward the housing body in the course of the electromagnetic pulse welding. According to one embodiment, the contact element has already been fastened in some other way, in particular by material closure; for instance, it has been welded to the housing body. Alternatively, the contact element, the housing body and also the base element can be welded together in one process by electromagnetic pulse welding. The space, or volume, that is formed by the shape of the contact element, including the contact link that extends away from the arrangement space, can expediently be utilized to insert a supporting element, for instance a disk-shaped supporting element, which remains in the cell. In order, as far as possible, not to waste any construction space, this supporting element has expediently been designed to be appropriately thin along the longitudinal axis.

According to one embodiment, the contact link(s) has/have been designed and shaped, or positioned, to be accelerated in the course of the welding procedure.

Alternatively, the housing body has been designed accordingly. For this purpose, the housing body expediently exhibits a fastening portion which has been designed and positioned to be accelerated in the course of the welding procedure.

As already follows from the aforementioned explanatory remarks, in reality there are many options for putting these aspects into effect.

According to one embodiment, the base element takes the form of a contact element. Accordingly, in this embodiment the base element not only forms the termination of the arrangement space but has also been connected to the electrode material in electrically conducting manner.

With respect to the material of the base element, it should also be mentioned that this element can likewise be produced from the same materials that were named in connection with the housing body. In particular, Hilumin, for instance, is also employed for the base element. Alternatively, the base element may have been formed from copper or from a material that, for instance, includes copper.

The material of the contact element is likewise expediently copper.

According to one embodiment, the housing body is the negative pole of the energy storage cell, the positive pole having been formed in or on the cover element. The contact element has correspondingly preferably been connected to the anode of the electrode material. The contact element may also be designated as a “negative conductor”. In the present case, the negative conductor has preferably been connected in electrically conducting manner to the housing body, also called a “can”. The second pole, correspondingly preferably the positive pole, has preferably been formed on the cover element of the energy storage cell, situated opposite the base element. The second pole has expediently been electrically insulated in relation to the cover element and/or the housing body.

The disclosure also relates to a method for producing an energy storage cell, comprising the following steps:
making available a housing body which extends along a longitudinal axis and has been designed to form an arrangement space for electrode material;
arranging electrode material in the arrangement space, and establishing an electrically conducting connection to the housing body;
fastening a base element to one end of the housing body by electromagnetic pulse welding for the purpose of establishing a gastight connection.

The advantages and features mentioned in connection with the energy storage cell apply to the method analogously and correspondingly, and conversely. To be emphasized are the extremely short process-times of a few microseconds, the non-contacting action of the magnetic field, the dispensing with additional materials or fluxing agents, and the fact that, in contrast to positive or force-closed joining methods, the structural members do not exhibit, or require, any notches or grooves in the joining region. Given suitable process conditions, the achievable strength of the connection lies above that of the weaker base material. Besides the good mechanical properties of the joints, these joints are expediently distinguished by impermeability to gas and by low electrical transition resistances. The base element can be fastened to the housing body on the outside or alternatively even from the inside.

The aforementioned electrode material has expediently been fastened to the housing body on the inside in electrically conducting manner via a contact element. The base element may have been fastened to the housing body indirectly via the contact element. Alternatively, the contact element can be used as a supporting element in the course of the electromagnetic pulse welding if the base element has been designed and positioned appropriately. In further advantageous manner, the contact element has also been fastened to the housing body by electromagnetic pulse welding. Particularly preferably, the method is conducted in such a manner that both the base element and the contact element are fastened to the housing body in the same process by electromagnetic pulse welding.

According to one embodiment, the method includes the following step:
using/arranging a supporting element, in particular a separate supporting element, for the purpose of supporting the structural-member portions to be connected in the course of welding.

Depending upon the configuration of the magnetic device, or of the magnetic coil, or upon the configuration of the base element or of the contact element, the supporting element can be applied to the housing body on the inside or on the outside.

According to one embodiment, the method includes the following step:
arranging a magnetic coil for the purpose of welding in such a manner that an acceleration of the structural member occurs in the radial direction.

Alternatively, the method includes the following step:
arranging a magnetic coil for the purpose of welding in such a manner that an acceleration of the structural member occurs in the axial direction.

In the case of electromagnetic pulse welding there is a structural member, or a partner to be joined, that is set in motion. In the aforementioned variant, in which the acceleration of the structural member occurs in the radial direction, both the housing body and the base element and/or the contact element can be configured and positioned in such a manner that they undergo an acceleration. In the variant in which the acceleration of the structural member occurs in the axial direction, expediently only the base element has been provided to undergo the acceleration. According to one embodiment, the function of the contact element has also been integrated into the base element.

### BRIEF DESCRIPTION OF THE DRAWINGS

Further advantages and features arise out of the following embodiments of energy storage cells and of methods with reference to the appended figures.

FIG. 1: shows a schematic view of an energy storage cell;

FIG. 2: shows a schematic view for illustrating an embodiment of the method;

FIG. 3: shows a further schematic view for illustrating a further embodiment of the method;

FIG. 4: shows a further embodiment for illustrating a further embodiment of the method;

FIG. 5: shows a further embodiment for illustrating a further embodiment of the method;

FIG. 6: shows a further embodiment for illustrating a further embodiment of the method;

FIG. 7: shows a further embodiment for illustrating a further embodiment of the method; and,

FIG. 8: shows a further embodiment for illustrating a further embodiment of the method.

### DETAILED DESCRIPTION OF THE DRAWINGS

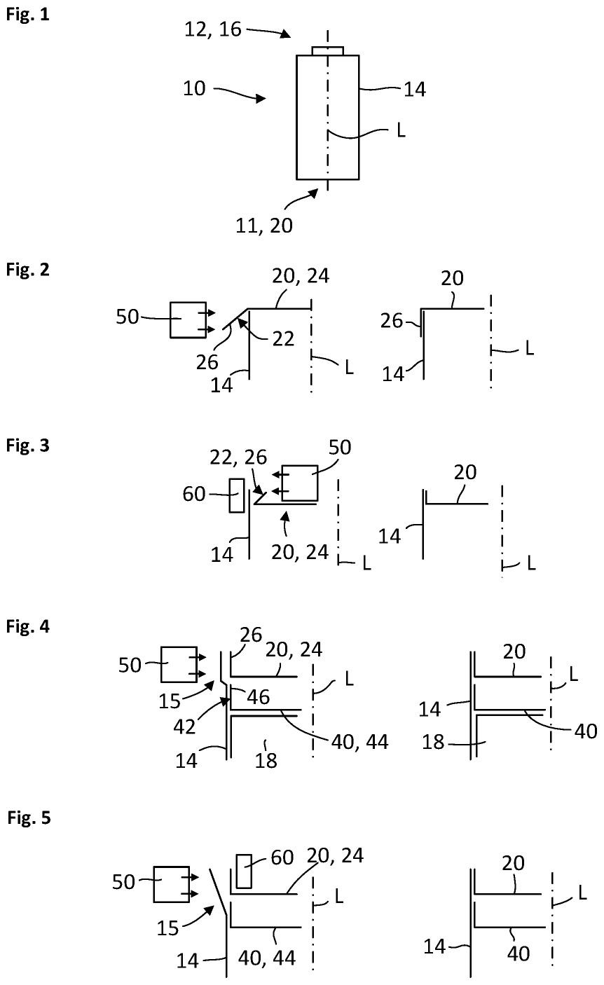

FIG. 1 shows schematically an energy storage cell 10, illustrated as a round cell, including a housing body 14 which extends along a longitudinal axis L. A base element 20 is arranged at a first end. A first or negative pole 11 has been formed there. At an opposing, second end, a cover element 16 has been arranged or formed. A second or positive pole 12 has been provided there. Methods for fastening the base element 20 to the housing body 14 by way of electromagnetic pulse welding are outlined in the following figures.

FIG. 2 shows, in a schematic partial view, a housing body 14 which extends along a longitudinal axis L. Reference symbol 20 denotes a base element which exhibits a central portion 24 and also a contact link 26. The contact link 26, on which a contact surface 22 has been formed, is accelerated in the direction of the housing body 14 with the aid of a welding device, or a magnetic coil 50. In the right half of the picture, the state can be seen in which the base element 20 has been fastened externally to the housing body 14 in gastight manner via the contact link.

FIG. 3 shows a further configuration of the method, wherein a base element 20, including a central portion 24 and also a contact link 26 together with a contact surface 22, is fastened internally to a housing body 14. On the outside, a support is effected with the aid of a supporting element which has been illustrated with reference symbol 16. In this configuration, the contact link 60 extends away from the arrangement space. The final state is represented in the right half of the picture.

FIG. 4 shows a further configuration of the method. In addition to a base element 20, a contact element 40 has also been illustrated here which exhibits a central portion 44 and also a contact link 46 which, in turn, includes a contact surface 42 which bears internally against the housing body 14, or has been fastened there. Here too, the fastening is effected by material closure, particularly preferably with the aid of a pressure-welding method such as resistance welding, cold pressure welding, friction welding or ultrasonic welding. Particularly preferred welding methods are resistance welding, projection welding or gap welding. According to a preferred embodiment, the contact element 40 has also been fastened with the aid of electromagnetic pulse welding. In the embodiment illustrated here, only the base element 20 has been fastened to the housing body 40 with the aid of the magnetic coil 50. For this purpose, the housing body 14 forms a fastening portion 15 which forms a corresponding gap toward the base element 20. The fastening portion 15 is accelerated toward the contact link 26 of the contact element 20 in the course of the electromagnetic pulse welding. However, given an appropriate configuration of the magnetic coil, or even given an appropriate design of the fastening portion 15, it can easily be imagined that both the base element 20 and the contact element 40 can be fastened simultaneously by electromagnetic pulse welding, compare also FIG. 7 for instance. An electrode material—such as, for instance, a cell wrap—has been illustrated with reference symbol 18. This cell wrap has been fastened to the contact element 40, for instance by way of welding, in particular laser welding.

FIG. 5 shows substantially the embodiment of the method known from FIG. 4. However, the possible application of a supporting element 60, for the purpose of supporting the partners to be joined from the inside, has also been illustrated. A fastening portion 15 has also been formed differently here, as compared to FIG. 4.

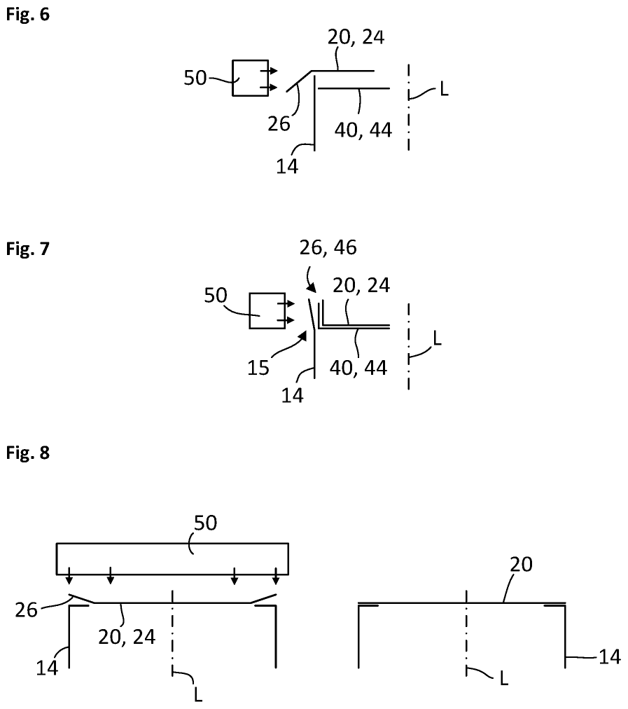

FIG. 6 shows an embodiment in which a contact element 40 takes the form merely of a disk-shaped element. Here, a base element 20 has been fastened externally to a housing body 14. Given appropriate configuration, it is possible that the contact element 40 here acts directly as a supporting element in the course of the welding process.

FIG. 7 shows a configuration in which both the base element 20 and the contact element 40 exhibit contact links 44 and 46, respectively, which extend away from the arrangement space of a housing body 14. The contact links 26 and 46 overlap in the radial direction. Both components can be fastened in one method step with a fastening portion 15 of the housing body 14 by way of electromagnetic pulse welding. Alternatively, a contact element configured as in FIG. 7 has already been fastened to the housing body 14 from the inside, and the contact link 26 of the contact element 20 has been formed as a moving structural member which in the course of the electromagnetic pulse welding is fastened to the contact link 46 of the contact element 40 from the inside.

FIG. 8 shows a further configuration of the method, a magnetic coil 50 being arranged here in such a manner that an acceleration of the structural member takes effect in the axial direction—that is to say, along the longitudinal axis L. A base element 20, including a central portion 24, exhibits an appropriately oriented, or reshaped, contact link 26 which has been designed and positioned to be accelerated in the direction of an appropriately configured housing body 14. For this purpose, the housing body 14 correspondingly exhibits on an end face—that is to say, at the first end—a link or flange which is directed to be substantially perpendicular to the longitudinal axis L, in order to serve, as it were, as a stop for the contact link 26 in the course of the electromagnetic pulse welding.

### LIST OF REFERENCE SYMBOLS

10 energy storage cell
11 first pole, negative pole
12 second pole, positive pole
14 housing body
15 fastening portion
16 cover element
18 electrode material
20 base element
22 contact surface
24 central portion
26 contact link
40 contact element
42 contact surface
44 central portion
46 contact link
50 welding device, magnetic coil
60 supporting element
L longitudinal axis

1.-15. (canceled)

16. An energy storage cell comprising:
a housing body which extends along a longitudinal axis and forms an arrangement space in which electrode material is arranged and has been connected to the housing body in a electrically conducting manner,
wherein the arrangement space is delimited at a second end by a cover element, and at a first end by a base element, and
wherein the base element has been fastened to the housing body in electrically conducting and gastight manner by electromagnetic pulse welding.

17. The energy storage cell according to claim 16,
wherein the base element exhibits a contact surface peripherally for the purpose of fastening.

18. The energy storage cell according to claim 16,
wherein the base element exhibits a central portion from which a contact link extends in the direction of the arrangement space or away therefrom, and
wherein the contact link bears against the housing body on the inside or on the outside.

19. The energy storage cell according to claim 16,
wherein the housing body is connected to the electrode material in a electrically conducting manner via a contact element, and
wherein the contact element exhibits peripherally a contact surface via which the contact element has been fastened to the housing body by electromagnetic pulse welding.

20. The energy storage cell according to claim 19,
wherein the contact surfaces have been designed and positioned to be fastened simultaneously by the electromagnetic pulse welding.

21. The energy storage cell according to claim 19,
wherein the contact surfaces each contact the housing body directly.

22. The energy storage cell according to claim 19,
wherein the contact surface of the contact element contacts the housing body indirectly via the base element.

23. The energy storage cell according to claim 19,
wherein the contact element has been designed and positioned to act as a supporting element in the course of welding.

24. The energy storage cell according to claim 19,
wherein the contact link(s) has/have been designed and shaped to be accelerated in the course of the welding procedure.

25. The energy storage cell according to claim 16,
wherein the housing body exhibits a fastening portion which has been designed and positioned to be accelerated in the course of the welding procedure.

26. The energy storage cell according to claim 16,
wherein the housing body constitutes the negative pole of the energy storage cell, and
wherein the positive pole has been formed in or on the cover element.

27. A method for producing an energy storage cell, comprising:
making available a housing body which extends along a longitudinal axis and has been designed to form an arrangement space for electrode material;
arranging electrode material in the arrangement space, and establishing an electrically conducting connection to the housing body; and,
fastening a base element to one end of the housing body by electromagnetic pulse welding for the purpose of establishing a gastight connection.

28. The method according to claim 27, further comprising:
arranging a magnetic coil for the purpose of welding in such a manner that an acceleration of the structural member occurs in the radial direction.

29. The method according to claim 27, further comprising:
arranging a magnetic coil for the purpose of welding in such a manner that an acceleration of the structural member occurs in the axial direction.

30. The method according to claim 27, further comprising:
using/arranging a supporting element for the purpose of supporting the structural-member portions to be connected in the course of welding.
